(19) United States
(12) Patent Application Publication
(10) Pub. No.: US 2009/0037986 A1
(43) Pub. Date: Feb. 5, 2009

(54) Non-disclosing password entry method

(75) Inventor: Daniel G. Baker, Beaverton, OR (US)

Correspondence Address: Lipsitz & McAllister, LLC, 755 MAIN STREET, MONROE, CT, 06468, US

(73) Assignee: Next Access Technologies, LLC, Stamford, CT (US)

(21) Appl. No.: 12/215,974

(22) Filed: Jul. 1, 2008

Related U.S. Application Data
(60) Provisional application No. 60/962,016, filed on Jul. 24, 2007.

(51) Int. Cl. H04L 9/32; G06F 21/00

(52) U.S. Cl. 726/5

(57) ABSTRACT

A non-disclosing password entry method is achieved by displaying an ordered arrangement or matrix of characters such that an authorized user's password is predetermined from a subset of these characters. The characters in the display are associated with a randomly ordered set of patterns or colors as, for example, the character background in the display. Additionally there is provided a means for selecting each type of pattern or color. Rather than entering the password directly, the authorized user is authenticated by noting the background pattern or color associated with the first character of the password and then selecting that pattern or color. The process is repeated with each password character in sequence until all the characters have been selected. The authorized user is authenticated by verifying that the selected backgrounds are correct for each of the characters of the password.

### CROSS-REFERENCE TO RELATED APPLICATIONS

This application is a non-provisional application which derives its filing date from provisional application Ser. No. 60/962,016 filed Jul. 24, 2007, which provisional application is expressly abandoned upon the filing of the present application.

### BACKGROUND OF INVENTION

The present invention relates to password security systems, and more particularly to a non-disclosing password entry method for an authorized user that reduces the possibility of access by an imposter.

It has long been known that the best way to identify an authorized user at a secure access point, while minimizing the chances of an imposter gaining access, is to base the identification on three basic items: something the authorized user has, something the authorized user is, and something the authorized user knows. The first one, something the authorized user has, is often accomplished by an ID card with electronically readable magnetic strip or, more recently, a Radio Frequency Identification (RFID) chip. The second, something the authorized user is, may be a finger print, retinal scan or some other unique biologic trait of the authorized user. However, biologic ID is still new and not shown to be fully robust in allowing the authorized user access in all conditions. Therefore, these methods are used only where security is paramount. The last, something the authorized user knows, is quite often a password or Personal Identification Number (PIN). This password method is used by virtually everyone and remains the most common method of authentication of identity. The password, or PIN, is something only the authorized user knows and, with today's strong encryption, the password may be transmitted over a network to authenticate the authorized user with little fear of the password being compromised by imposters.

However, although the password may be securely transmitted in the presence of a. imposters by the use of encryption, the password may still be disclosed to an imposter before or during the password entry process. For example, many ATM keypads are visible to people waiting in line where an imposter may observe the keypad selections and obtain the authorized user's PIN simply by looking over the authorized user's shoulder (called “shoulder-surfing”). Alternatively, a secluded imposter may obtain the password by watching with binoculars from a nearby car or building.

With the ubiquitous use of video surveillance the password or PIN entry process may be easily video recorded. Therefore, even methods that obscure the PIN or password entry may disclose the PIN or password when the video tape is played back in slow motion. For example a method disclosed by Volker Roth and Kai Richter in a paper called “How to Fend off Shoulder Surfing”, published in the Journal of Banking & Finance, June 2006, Vol. 30 Issue 6, pgs. 1727-1751, discloses a method of obscuring the disclosure of the PIN from imposters or “shoulder-surfers”. However, by playing back a video tape of the entry process by the “prover” it is quite easy to isolate each number of the PIN in the same way as the ATM terminal or “verifier” isolates the PIN characters to authenticate the authorized user. For example the paper discloses this as follows, “it holds that, if the observer can perfectly record or memorize all input and output then he or she will be able to deduce the prover's PIN in the same fashion as the verifier does it.”

Another limitation of this method is that it requires 4 key-presses for each number of the PIN. For example, 16 key-presses would be required for a simple 4-digit PIN. A further limitation of the method in this paper is it's limitation to numeric keypads. It is not obvious how to extend this to alpha-numeric password entry without requiring a very large number of selections for each element of the password, making it very tedious to use. For example, a 6-digit password selected from a character set of 36 alphanumeric characters would require at least 6 key-presses per character or 36 key-presses in total.

Passwords are also the dominant means of user authentication via the keyboard or mouse of a computer. It may be more difficult for someone to see and memorize the password by watching the authorized user's fingers at the keyboard, or mouse icon position on the screen, than watching an ATM keypad, but it does happen. Also small cameras may be placed and removed to allow all keyboard strokes and mouse display clicks to be recorded for later playback.

Also, the disclosure of passwords is a serious issue with computer keyboard or mouse selection entry of passwords when using a device connected to the internet. For example, a common method of password theft is now being done by a simple spy-ware program that logs keystrokes and/or mouse screen position clicks and sends that log back over the internet without your knowledge. This log can then be filtered to find account numbers and passwords.

Also, there is a growing problem with password theft by the method of presenting a fake or duplicate log in a screen called a “Trojan Horse”. This duplicate looks just like the one normally seen by the authorized user when entering an account number and password, but is a fake to capture the authorized user's vital information. Any method where the characters of the password are indicated, either by key presses or mouse clicks, discloses the password to the Trojan log-in or fake authentication page.

U.S. Pat. No. 5,428,349, entitled “Non-disclosing Password Entry”, issued to Daniel G. Baker on Jun. 27, 1995, teaches a method of securely entering a password to authenticate an authorized user log-in to a secure data service. The method disclosed in the '349 patent is that of selecting the row or column of a randomized (shuffled) matrix of alpha-numeric characters that contains each, in succession, of the characters of the user password. The individual characters of the password are not specifically selected or typed, since only rows or columns of the character matrix are selected. Therefore, the method taught by the '349 patent is resistant to all the aforementioned problems, since it does not explicitly disclose the password by the key press or mouse click entry process. However, the '349 patent requires the authorized user to visually scan through the randomized matrix for each character of the password to identify the row or column. This may take some time, and some authorized users may consider this too tedious.

What is desired is a method that is resistant to all the aforementioned problems, easier to learn, and less tedious to use by reducing the key-presses to no more then one per password character, and that eliminates the need to scan a random arrangement of characters for each character of the password.

### SUMMARY OF THE INVENTION

Accordingly, the present invention provides a non-disclosing password entry method that is achieved by displaying an ordered arrangement or matrix of characters such that an authorized user's password is predetermined from a subset of these characters. The characters in the display are associated with a randomly ordered set of patterns or colors as, for example, the character background in the display. Additionally there is provided a means for selecting each type of pattern or color. Rather than entering the password directly, the authorized user is authenticated by noting the background pattern or color associated with the first character of the password and then selecting that pattern or color. The process is repeated with each password character in sequence until all the characters have been selected. The authorized user is authenticated by verifying that the selected backgrounds are correct for each of the characters of the password.

The objects, advantages and other novel features of the present invention are apparent from the following detailed description when read in conjunction with the appended claim and attached drawing.

### BRIEF DESCRIPTION OF THE SEVERAL VIEWS OF THE DRAWING

FIG. 1 is a flow chart view a method of non-disclosing password entry according to the present invention.

FIGS. 2a-2f are plan views of successive screen views illustrating the non-disclosing password entry according to the present invention.

FIG. 3 is a plan view of an alternative character matrix and entry keys according to the present invention.

FIG. 4 is a plan view of another alternative character matrix and entry keys according to the present invention.

FIG. 5 is a plan view of still another alternative character matrix and entry keys according to the present invention.

FIG. 6 is a plan view of yet another alternative character matrix and entry keys according to the present invention.

### DETAILED DESCRIPTION OF THE INVENTION

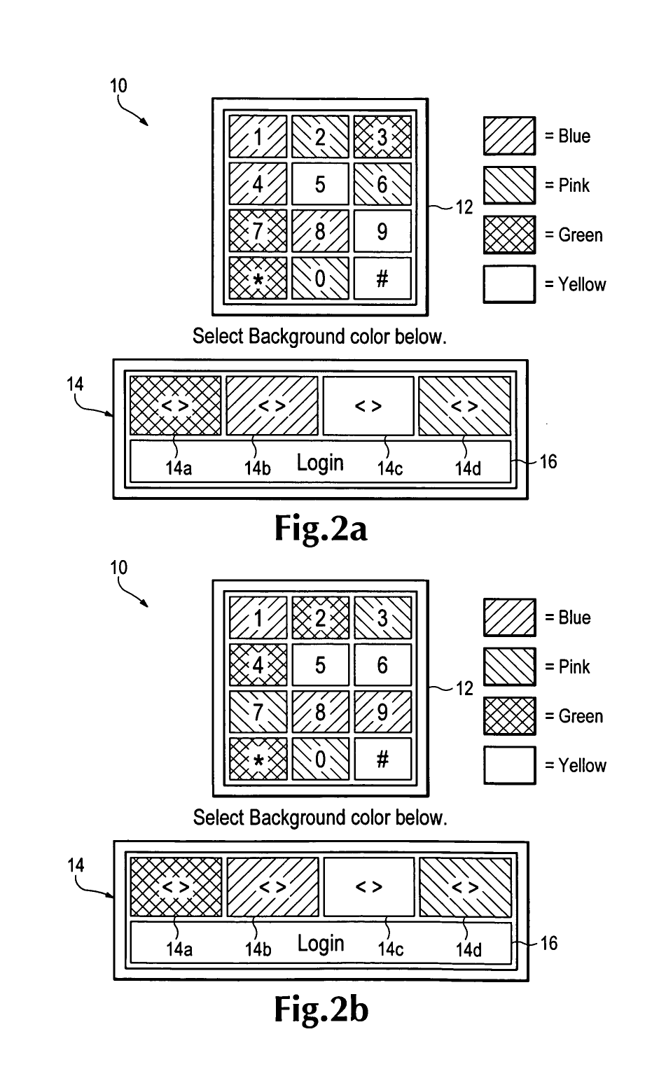

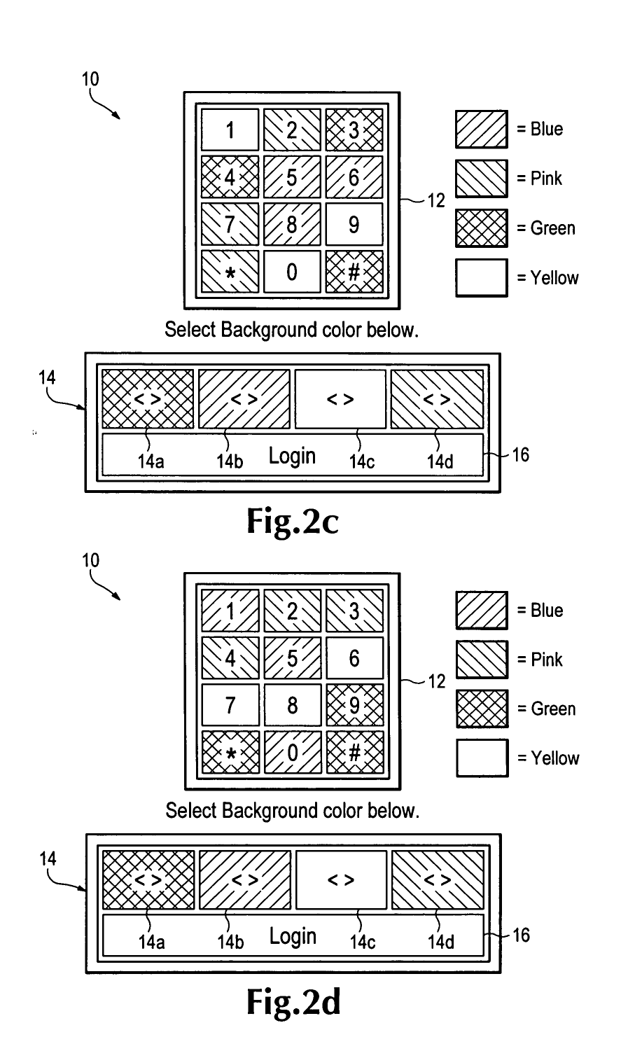

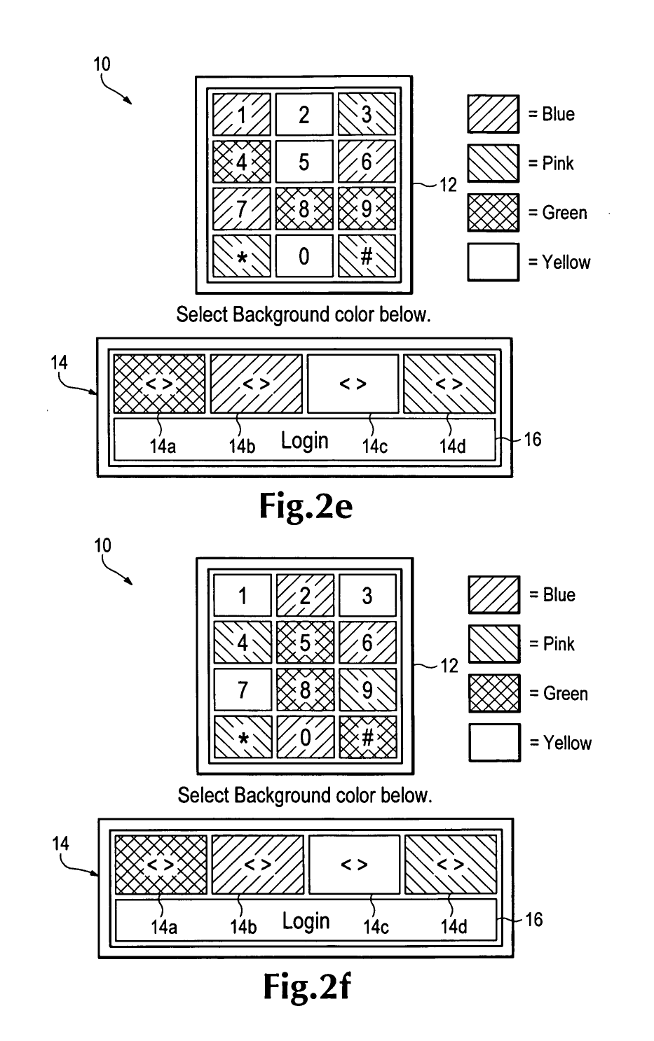

Referring now to FIGS. 2a-2e, one method of non-disclosing password entry is illustrated. Variations of the described method are apparent to one of ordinary skill in the art. Assume a user personal identification number (PIN) of 17779. The user, after entering a user name using a physical identifying device (ID card) or typing in a user name sequence on a conventional keyboard, for example, sees a display 10, as shown in FIG. 2a, that has a static matrix of characters 12 (in this simple example a numeric telephone keypad is shown), with each character having one of four different background colors—blue, pink, green and yellow for this example. Below the static matrix 12 are entry keys 14, each coded with one of the background colors. Below the entry keys 14 is an optional login key 16 for the user to indicate that the PIN has been entered, or for fixed PIN lengths the system automatically authenticates after the last character entry.

The user uses the entry keys 14 to select the color of the character corresponding to the first character of the PIN—in this case the numeral “1” has a blue background, so the user activates the blue entry key 14b. A new set of background colors is then generated randomly, as shown in FIG. 2b. Again the user activates the appropriate entry key 14d—pink since the second number in the PIN is “7”, and the backgrounds of the character matrix 12 are shuffled again, as shown in FIG. 2c. The user activates the pink entry key 14d again corresponding to the next PIN number “7”, and the backgrounds are shuffled again, as shown in FIG. 2d. The yellow entry key 14c is activated for the next number “7”, and the backgrounds are shuffled yet again, as shown in FIG. 2e. Finally the user activates the green entry key 14a for the last number “9”, and the backgrounds of the character matrix 12 are shuffled again. Either immediately, or upon activation of the Log In key 16 by the user, a notification appears or some other action occurs that indicates successful log in by the user.

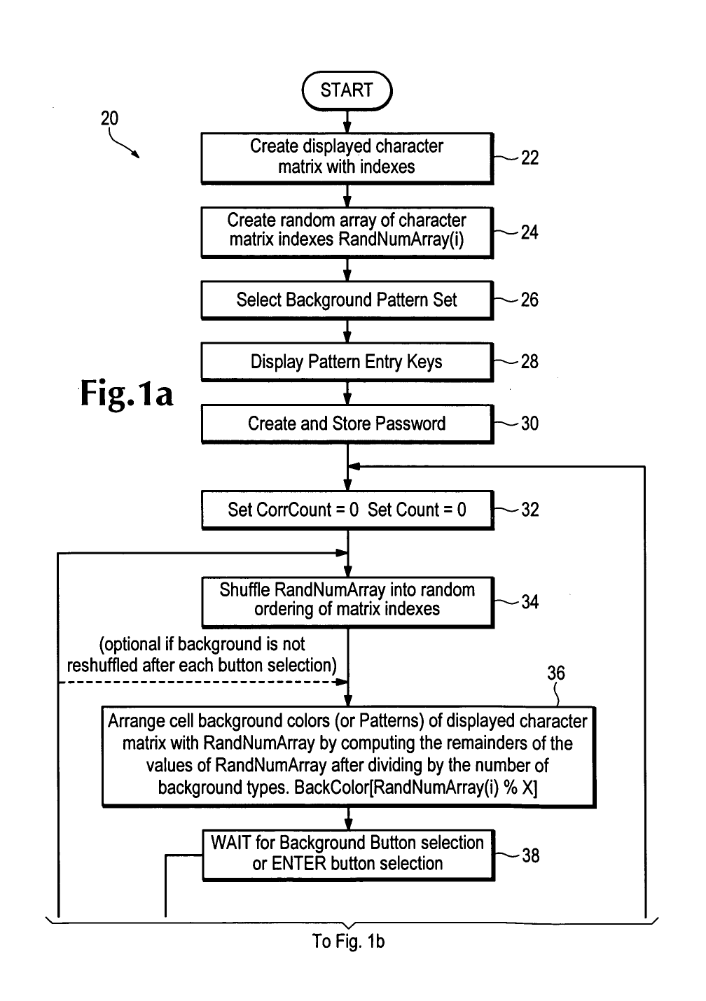

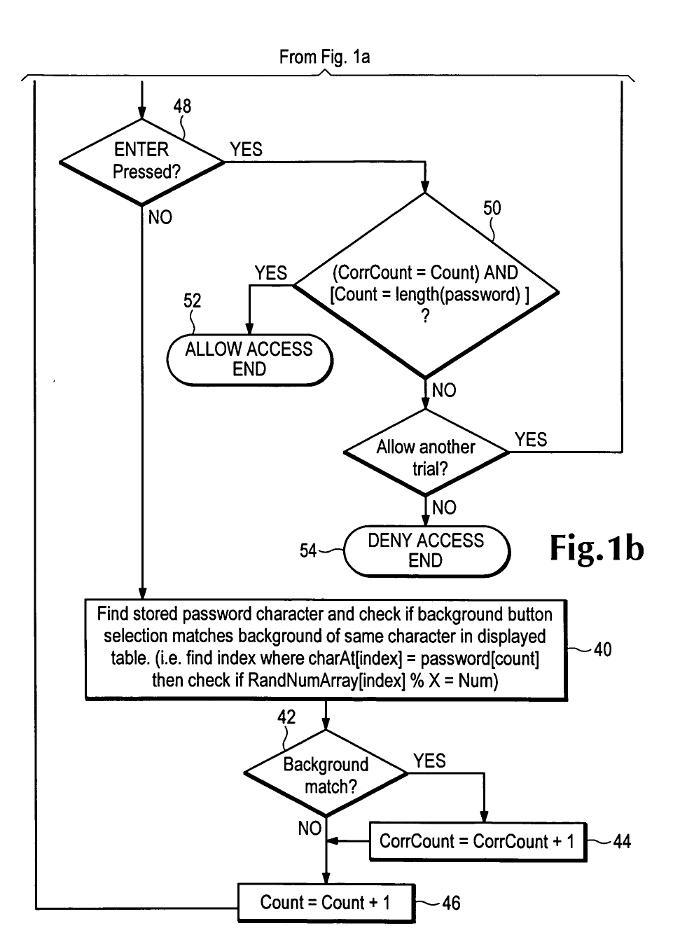

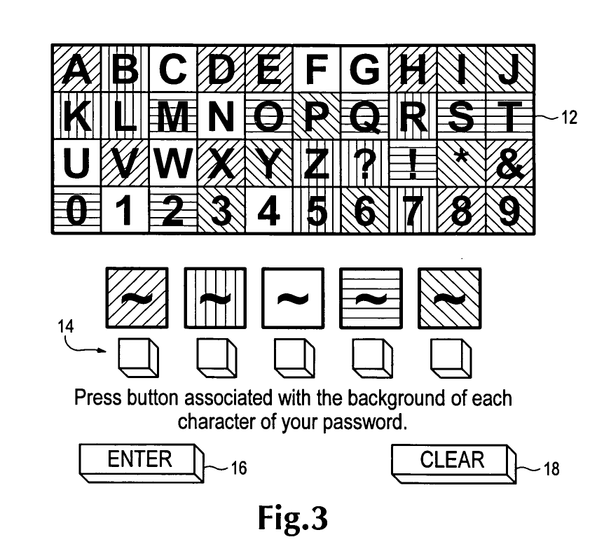

The method is illustrated in more detail by the flowchart view 20 of FIG. 1.
1) Arrange an alpha-numeric character matrix 12. Allow each character to have a selectable background. (Step 22)
2) Assign to each character location the numbers 0 . . . n−1, where n is the number of characters in the matrix 12, and create an array of these numbers, RandNumArray[0 . . . n−1] with index values i=0 . . . n−1, i.e., RandNumArray[i]. The variable i becomes an index pointing to each character position in the matrix 12, i.e., i=0 corresponds to the first character, i=1 to the second character, and so on. (Step 24)
3) Select a set of x different background colors and assign the digits 0 . . . x−1 to the background colors. For example, define BackColor[0]=diagonal-lines, BackColor[1]=horizontal/vertical crosshatch-lines, etc. (Step 26)
4) Provide a means for selection 14 of each of the x background types. For example, Button0=BackColor[0], Button1=BackColor[1], etc. Also provide a means to Enter 16 the completed password entry, such as an Enter or Log In button (where the password entry may have a variable length). Also a Clear button 18 is useful to allow the user to restart the entry process if a mistake is made. Refer to FIG. 3 for an example. (Step 28)
5) Create a password for the user of M characters and store in array Password[Count] where Count=0 . . . M−1 acting as a pointer to each character of the password. For example if the password is PASS1, Password[0]=P, Password[1]=A, etc. (Step 30) If using a numeric password or PIN=17779, then Password[0]=1, Password[1]=7, etc.
6) Create variable CorrCount and set CorrCount and Count to zero at the beginning of the password entry process. (Step 32)
7) Shuffle the values of RandNumArray into a random ordering by using a suitable shuffling algorithm. An example of a simple shuffling algorithm based on a common pseudo-random number generator is included in the sample javascipt later in this document. For example, RandNumArray[0]=24, RandNumArray[1]=12, RandNumArray[2]=0, etc. (Step 34)
8) Assign a random background to each character in the matrix 12 as follows:
   Find the index of the background type as the remainder of each number in the matrix 12 after dividing by x. For example, k=RandNumArray[i]% x, where i is the index of each of the n characters and BackColor[k] indicates one of the x backgrounds. For example, BackColor[0]=diagonal-lines on the first character, BackgColor[1]=horizontal/vertical crosshatch-lines on the second character, etc. Each background type is repeated a number of times, depending upon the number of characters divided by the number of backgrounds. The symbol “%” indicates the modulo operator, i.e., 12%5=2. (Step 36)
9) After each user button 14 selection (Step 38) check for correct background selection as follows:
   a) Find the Index of the displayed character array that matches the password character at Password[Count].
   b) Compute (RandNumArray[Index]% x) and check if it matches the pattern associated with the button 14 pressed. For example, if Button0 14a is pressed, then the result of the calculation should be 0 to match the pattern associated with that button. (Step 40)
   c) If the correct button 14 is pressed (Step 42), then increment CorrCount, and always increment Count (Steps 44 and 46). In any event increment Count. At this point the steps 7 and 8 can be optionally repeated to re-randomize the background patterns associated with the displayed, ordered character matrix 12.
   d) Repeat steps a, b, and c above until the user presses the Enter button 16, or the fixed number of entries for the password have been entered.
10) After Enter button 16 is pressed or the fixed number of password characters have been entered (Tested at Step 48), compare CorrCount with Count (Step 50) and, if they match, the authorized user is authenticated (Step 52), otherwise access is denied (Step 54) or another trial is allowed. It is common practice to allow 3 trials to allow for mistakes before denying access and disabling further attempts. For each trial CorrCount and Count should be reset to zero.
   Many character or symbol matrices 12 are possible and may be any suitable set of graphical icons, pictures, or other symbol types from which a memorized sequence (password) may be formed. The grouping need not be the rectangular ordering shown, but may be any readable arrangement, such as a circle or ring of characters.

Although the characters in the preferred embodiment are associated with background patterns, any color, picture or pattern or other characteristic set may be randomly arranged in the shuffling process and associated with each character in the password matrix 12. Further, the shuffled patterns need not be the background of the character, but may be associated by adjacent special alignment or other possible associations of each pattern to the displayed ordered character matrix 12 (not shown).

The memorization or recording by an imposter of every detail of a correct password entry process, including the entire character matrix with associated background at each step, does not disclose the password. For example, for a 40 character set with five backgrounds, assume the authorized user has a relatively short 6-character password. The imposter sees 8 possible characters for each of the selected 6 background button entries (one for each character of the password). After full observation of the entire display 10 and all button presses for the entire process, this creates a possible set of 8 [symbol] 6=2 [symbol] 18 which is 262,144 possible passwords. A longer password, such as an 8 character password, increases the set to over 16 million possible passwords, even after recording every detail of the password entry process.

Further, using passwords that are themselves acronyms makes sorting through this large set of possible passwords for common words even more difficult. For example, using an alpha-numeric set of characters, an authorized user may use the password MHALL! by recalling the simple phrase “Mary Had A Little Lamb!”. Another example is MDN2GL for “My Dog's Not Too Good Looking”.

If an imposter attempts access by randomly pushing buttons, it is possible, with a low probability, to gain access. However, if the imposter does not know the number of characters in the authorized user's password, the chances are zero for any sequence of button pushes that does not equal the number of password characters. As previously described, the password is not disclosed, even if all the button presses are seen by the imposter. But since the imposter may determine the length of the password, the imposter may use this knowledge to attempt access by randomly choosing each button press. For the 5-button example shown in FIG. 3, the probability for random guessing is (1/5) [symbol] 6 or 1 chance in 15,625. This means random guessing is less likely of success than randomly guessing a 4-digit ATM PIN, since there are only 10,000 PIN combinations.

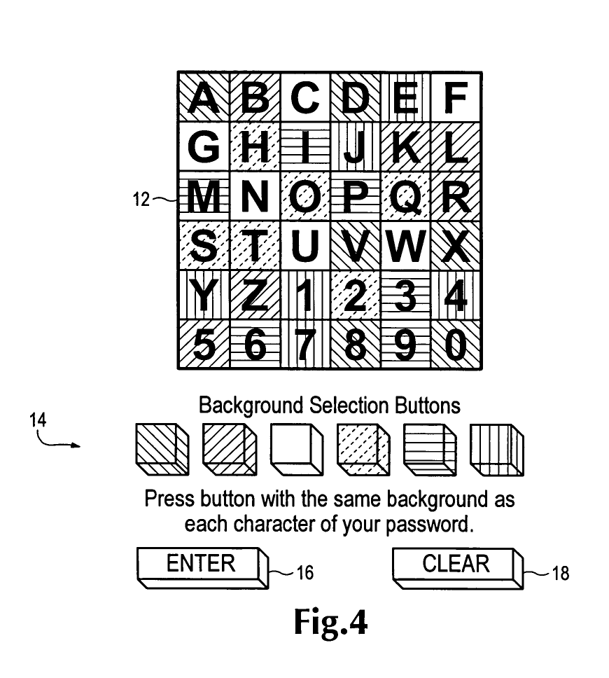

Alternative configurations that trade off the probability of guessing the password against authentication by random button pressing are evident to one of ordinary skill in the art. For example, FIG. 4 shows the character array as the 36 alpha-numeric character set and 6 background pattern selection buttons. In this example the disclosed number of possible passwords from a single, full recording of the entire entry process is 6 [symbol] M where M is the length of the password. For a six-character password, M=6, providing 6 [symbol] 6=46,656 passwords. This is less than the first example but the probability of randomly selecting the 6 background buttons is (1/6) [symbol] 6, or one chance in 46,656 which is about 3 times more secure than the first example.

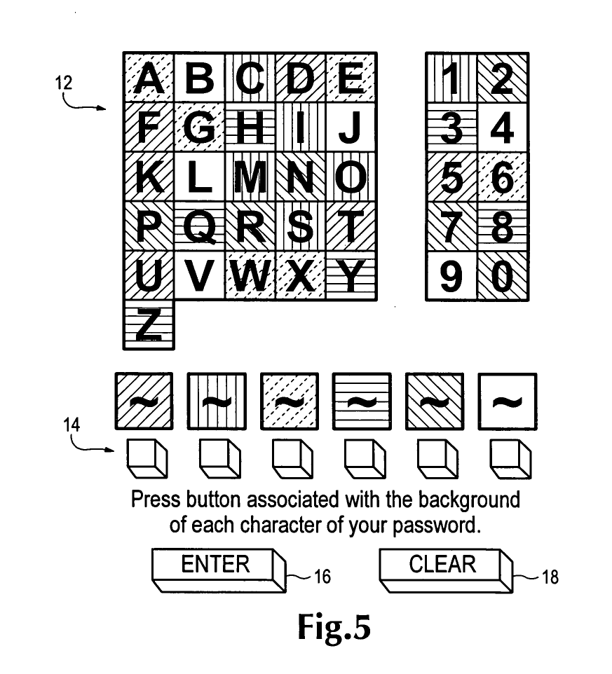

FIG. 5 is another example with the same probability as FIG. 4, but allows for a different matrix configuration of the password character set to allow for easier visual scanning for each character of the password. Many other configurations are apparent to one of ordinary skill in the art.

In general, any set of characters of length J that may be factored into the product P×Q has P different types of background patterns and pattern selection buttons with each pattern repeated 0 times in the character set. In the example of FIG. 3, J=40, P=5, and Q=8. In the examples of FIGS. 4 and 5, J=36, P=6, and Q=6. Therefore, for a password length of M characters, the number of possible passwords disclosed in a single, full recording of the entry process is Q [symbol] M and the probability of authentication from random guessing (knowing the length of the password) is 1/P [symbol] M.

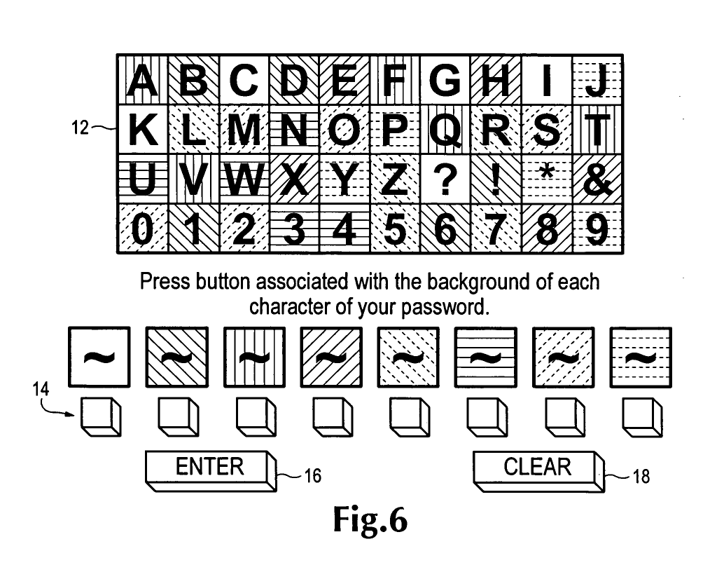

FIG. 6 shows an example where the application requires more security from random guessing but, since the display is in an area that is not easily observed or keystrokes/mouse-clicks are not easily recorded, provides less security against password disclosure. In this example J=40, as in FIG. 3, but P=8 and Q=5. Therefore, there are 8 different background patterns, each repeated 5 times. For a 6 character password, the number of possible passwords in a single, full recording of the entry process is 5 [symbol] 6=15,625, and the probability of authentication from random button pressing is 1/8 [symbol] 6 or 1 in 262,144.

The following source-code is from a Javascript demo program that displays the 36 alpha-numeric characters plus 4 additional symbols for a total of 40 characters. Rather than background patterns, as shown in FIG. 3, this example uses 5 different colors for character backgrounds, similar to the example of FIG. 2 (which uses four different colors).

```
<!-- =========== Begin =============
// Nondisclosing password entry code. Written by Dan Baker
// all rights reserved. July 2007.
// 10×4 array of alpha-numeric characters and punctuation
var Password = “PASS1” //Default password, not case sensitive
//Beginning of Random character background functions
var CharString
= “ABCDEFGHIJKLMNOPQRSTUVWXYZ&!@?0123456789”
var Size = CharString.length //Size = 40 in the example character
string above.
RandNumArray = new Array(Size)
BackColor = new Array(5)
var Count = 0
var CorrCount = 0
var today = new Date( ) // needed for random seed
//background color or patterns
BackColor[0] = “#00FF00” //Green background
BackColor[1] = “#FFFF00” //Yellow background
BackColor[2] = “#00FFFF” //Cyan background
BackColor[3] = “#FF00FF” //Magenta background
BackColor[4] = “#FF2222” //Red background
//Standard Password form
// checks both matix and password text entry
function verifyLogin( ) {
    var myForm = document.login;
    if ( (CorrCount == Count) && (Count > Password.length − 1) ) {
        confirm(“Congratulations “+myForm.username.value+”! Login
successful.\n\n Would you like to try
            it again? \nYou can change the password in the box at
            the bottom
if you want.”);
        document.login.password.value = “”;
          reset_count( );
        }
    else {
      alert(“Unknown username or wrong password.\nPlease try again.”);
      document.login.password.value = “”;
        reset_count( );
      }
}
//Matrix character count reset
function reset_count( ) {
Count=0;//count of selections
CorrCount=0;//count of correctly selected background color pattern
}
//Pseudo random integer generator
function rand(N) { // random integer generator, result is random int 0..N−1
  var seed = today.getTime( ) % 0xFFFFFFFF;
  seed = (0x015A4E35 * seed) % 0x7FFFFFFF;
  return (seed >> 16) % N;
}
//Initialize random number array in order 0..Size−1
function initnumarray( ) {
for (var i=0; i < Size; i++) {
    RandNumArray[i] = i;
  }
}
//SHUFFLING ALGORITHM
//Shuffle array by using available rand( ) function
function shuffle(RandomArray, Size) {
for (var i=Size−1; i>0; i−−) {
  var z = rand(i);
  var temp = RandomArray[i];
  RandomArray[i] = RandomArray[z];
  RandomArray[z] = temp;
}
}
//Function to change background of matrix cell values
function ChangeCellBackgroundColor(row, cell, Color){
    row.cells(cell).style.background=Color;
}
//Reload display table with random background color.
//Use remainder after dividing cell number by 5 to determine background
pattern
color
//Each background type will be repeated 8 times.
function DisplayRanBackgroundTable( ) {
shuffle(RandNumArray, Size);// shuffle cell numbering sequence to make
random backgrounds
for (var i=0; i<10; i++) {
  ChangeCellBackgroundColor(tr0, i,
BackColor[RandNumArray[i] % 5]);//1st row of 10 cells
  }
for (var i=0; i<10; i++) {
  ChangeCellBackgroundColor(tr1, i,
BackColor[RandNumArray[i+10] % 5]);//2nd row
  }
for (var i=0; i<10; i++) {
  ChangeCellBackgroundColor(tr2, i,
BackColor[RandNumArray[i+20] % 5]);//3rd row
  }
for (var i=0; i<10; i++) {
    ChangeCellBackgroundColor(tr3, i,
BackColor[RandNumArray[i+30] % 5]); //4th row
    }
}
//Check for correct password character with selected background color
function IsCharColor(Num) {
if (Num > 4) return false;
for (i=0; i<Size; i++) { //find i value of password character
  if (CharString.charAt(i) == Password.charAt(Count)) var Temp = i;
}
if ((RandNumArray[Temp] % 5) == Num) return true; //check if
background is
correct
return false;
}
//Main function called by background selection
function CheckPassword(ColorNum) {
  if (IsCharColor(ColorNum)) CorrCount += 1;//increment only if color
  correct
  Count += 1;
  DisplayRanBackgroundTable( );
  document.login.password.value = document.login.password.value +
  “X”; //write
dummy value into password form
}
initnumarray( );
DisplayRanBackgroundTable( );
// Insert 5 button selection functions, one for each background pattern
or color
// onClick=“CheckPassword(0)”
// onClick=“CheckPassword(1)”
// onClick=“CheckPassword(2)”
// onClick=“CheckPassword(3)”
// onClick=“CheckPassword(4)”
// ============= End =============== -->
```

Thus the present invention provides a non-disclosing password entry method that uses a standard character matrix with variable backgrounds for each character, each character of the password being entered according to the corresponding background, with the background being shuffled between each password character entry so there is only one keystroke/mouse click per password character. After each password character is identified and the authorized user indicates completion (or the fixed length of a non-variable length password is reached), the authorization algorithm indicates success or failure of login.

What is claimed is:

1. A method of non-disclosing password entry comprising the steps of:
providing a display of a matrix of characters, each character having a variable background selected from a defined set of backgrounds;
providing a plurality of entry keys, one for each background of the defined set;
selecting of one of the entry keys corresponding to the background in the matrix corresponding to a first character of an authentication code assigned to a specified user, the authentication code having a plurality of characters in sequence;
verifying that the background for the first character within the array of characters corresponds to the entry key selected in the user selecting step;
scrambling the variable backgrounds for the array of characters after the user selecting step;
repeating the user selecting, verifying and scrambling steps for each of the remaining characters of the authentication code in sequence; and
authenticating the authentication code after all the characters in sequence have been verified in the verifying step.

2. The method as recited in claim 1 wherein the matrix of characters comprises a set of characters selected from the group consisting of numerals, alphanumeric characters, symbols, pictures, graphical icons and combinations thereof.

3. The method as recited in claims 1 or 2 wherein the defined set of backgrounds comprises one selected from the group consisting of colors, shadings, figures, patterns and combinations thereof.

4. The method as recited in claim 1 further comprising the step of providing an error message when there is not a correspondence between the entry key selected and the background of the character in the character array corresponding to the character within the authentication code being verified in the verifying step after the authenticating step.

5. The method as recited in claim 4 further comprising the step of restarting the password entry with the first character of the authentication code by returning to the user selecting step.

6. The method as recited in claim 5 further comprising the step of terminating the password entry when the error message is generated a specified number of times after the authenticating step.

7. The method as recited in claim 1 wherein the variable background comprises an adjacent association for each character in the matrix.

8. The method as recited in claim 1 wherein the matrix of characters comprises one selected from the group consisting of a rectangular array, a circular array and any readable arrangement of characters.
